(19) United States
(12) Patent Application Publication
(10) Pub. No.: US 2014/0211140 A1
(43) Pub. Date: Jul. 31, 2014

(54) Alignment Film Material and Corresponding Liquid Crystal Panel

(71) Applicant: Shenzhen China Star Optoelectronics Technology Co. Ltd., Shenzhen, Guangdong (CN)

(72) Inventor: Xinhui Zhong, Shenzhen City (CN)

(73) Assignee: Shenzhen China Star Optoelectronics Technology Co., Ltd., Shenzhen Guangdong (CN)

(21) Appl. No.: 13/824,407

(22) PCT Filed: Jan. 31, 2013
(86) PCT No.: PCT/CN13/71229

§ 371 Date: Mar. 18, 2013

(30) Foreign Application Priority Data
Jan. 25, 2013 (CN) 201310028184.8

(51) Int. Cl. G02F 1/1337

(52) U.S. Cl. CPC G02F 1/133711
USPC 349/123; 524/104; 524/111

(57) ABSTRACT

The present invention provides an alignment film material, which is used for a liquid crystal display with polymer stabilized vertical alignment, it comprises: a polymer, an oligomer, and a solvent, wherein, the polymer and/or the oligomer comprise group structures of the benzophenone and methyl acrylate. Accordingly, the present invention also provides a liquid crystal panel using the above alignment film. The embodiments according to the present invention regulates the reaction rate of the polymerizable monomer and the polymerizable monomer residues in the polymer stabilized vertical alignment crystal mixture using the alignment film material, which controls the contents of the movable ion in the liquid crystal panel, in order to improve the reliability of the quality of the LCD panel.

This application claims priority to Chinese Patent Application Serial No. 201310028184.8, named as “Alignment film material and corresponding liquid crystal panel”, filed on Jan. 25, 2013, the specification of which is incorporated herein by reference.

### BACKGROUND OF THE INVENTION

1. Field of the Invention

The present invention relates to a liquid crystal display technology, in particular to an alignment film material and the corresponding liquid crystal panel.

2. The Related Arts

The liquid crystal used for twisted nematic (TN) or super twisted nematic (STN) liquid crystal display is positive-type liquid crystal. The long axis of the liquid crystal molecules is parallel to the surface of the substrate when the power is off. The alignment direction of the liquid crystal molecules on the surface of the substrate depends on the rubbing direction of alignment layer, which material usually is polyimide. The alignment directions of the surface of both substrates are perpendicular to each other. Hence, the molecules within the liquid crystal layer maintain in continuous twisted alignment state from the surface of one substrate to the surface of the other substrate. After the voltage is applied, the long axis of the liquid crystal molecules will tend to be aligned along the direction of the electric field. The drawback of the TN/STN type liquid crystal display is that it has small viewing angle, brightness difference and significant chromatic aberration under large viewing angle, which needs to be improved by the compensation film and thereby increases the manufacturing cost of the display.

Multi-domain vertical alignment (MVA) TFT-LCD using negative type liquid crystal and vertically aligned film material has solved the restrictions of the viewing angle of TN/STN display. When no voltage is applied, the long axis of the liquid crystal molecules is perpendicular to the surface of the substrate. When the voltage is applied, the liquid crystal molecules will topple down and the long axis of the liquid crystal molecules will tend to be aligned along the vertical direction of the electric field. In order to solve the problems of the viewing angle, a sub-pixel is divided into multiple regions, so that the liquid crystal molecules can topple down in different direction, which makes the views of the display seen in different directions tend to be the same. There are several ways to allow the liquid crystal molecules in the different regions to be oriented in different directions in one sub-pixel. The first one is to build a bump at the upper and lower substrates of the LCD by exposure and development, so that the liquid crystal molecules around the bump can produce a certain pre-inclined angle and topple down toward the fixed direction. The second one is to form predetermined pattern of indium tin oxide (ITO) pixel electrodes at the upper and lower substrates, which will generate an electric field with a certain inclined angle to control the toppling direction of the liquid crystal molecules in the different regions. This is called as patterned vertical alignment (PVA) technology. The third one is to form ITO slits at the TFT side of the LCD substrate and full ITO at the other side. And then add the polymerizable monomer into the liquid crystal medium. First, make the liquid crystal molecules topple down by an electric field, at the same time, irradiate the monomer with ultraviolet light to polymerize and form the polymer particles which can guide the toppling direction of the liquid crystal molecules. The polymer particles deposited on the surface of the substrate play the role of the alignment. This is called as polymer stabilized vertical alignment (PSVA).

The key process in PSVA is the control of the monomer reaction, which comprises the reaction rate, the reaction uniformity, the final residue control of the monomer, etc. Only good control of the above situation is able to get the PSVA LCD panel with high quality. Actually, it is still an important issue to well control the concentration of monomer after the ultraviolet UV irradiation process.

### SUMMARY OF THE INVENTION

The technical issue to be solved by the present invention is to provide an alignment film material used for a liquid crystal display with PSVA and the corresponding liquid crystal panel, which allows the monomer concentration of the panel to be controlled at lower level after the UV irradiation process. Simultaneously, it does not significantly increase the content of the movable ion in the panel, which avoids the declining quality issue due to the monomer residue or high ion concentration appeared in the panel during RA experiments and the following use.

To solve the above technical issue, the present invention provides an alignment film material, which is used for a liquid crystal display with polymer stabilized vertical alignment, characterized in that the alignment film material comprises: a polymer, an oligomer, and a solvent, wherein, the polymer and/or the oligomer comprise group structures as following:

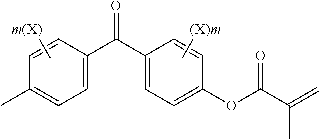

wherein, X represents a substituent group, the substituent groups Xs at different positions are independent of each other, which may be the same or different; m represents the number of the substituent groups Xs on each benzene ring, the numbers ms of the substituent groups on each benzene ring are independent of each other, which may be the same or different; the solvent comprises one or several of the following solvents: N-methyl pyrrolidone solvent, N-ethyl pyrrolidone solvent and butyrolactone solvent; and the weight of the solvent accounts for 80-99% of the total weight of the alignment film material.

Wherein, the molecular weight of the polymer is greater than 10,000, and the molecular weight of the oligomer is less than 10,000.

Wherein, the alignment film material further comprises a leveling agent and a defoamer.

Correspondingly, the present invention provides an alignment film material, which is used for a liquid crystal display with polymer stabilized vertical alignment, characterized in that the alignment film material comprises: a polymer, an oligomer, and a solvent, wherein, the polymer and/or the oligomer comprise group structures as following:

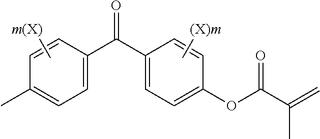

wherein, X represents a substituent group, the substituent groups Xs at different positions are independent of each other, which may be the same or different; m represents the number of the substituent groups Xs on each benzene ring, the numbers ms of the substituent groups on each benzene ring are independent of each other, which may be the same or different.

Wherein, the solvent comprises one or several of the following solvents: N-methyl pyrrolidone solvent, N-ethyl pyrrolidone solvent and butyrolactone solvent.

Wherein, the weight of the solvent accounts for 80-99% of the total weight of the alignment film material.

Wherein, the molecular weight of the polymer is greater than 10,000, and the molecular weight of the oligomer is less than 10,000.

Wherein, the alignment film material further comprises a leveling agent and a defoamer.

Accordingly, on the other aspect of the embodiment of the present invention, it provides a liquid crystal panel, which comprises:

a first transparent substrate, which comprises a first alignment film;
a second transparent substrate, which comprises a second alignment film; and a liquid crystal composition, which is filled between the first transparent substrate and the second transparent substrate, and the liquid crystal composition contacting with the first alignment film and the second alignment film;
wherein, the alignment film material comprises: a polymer, a oligomer, and a solvent, the polymer and/or the oligomer comprise group structures as following:

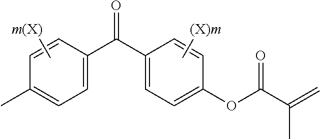

wherein, X represents a substituent group, the substituent groups Xs at different positions are independent of each other, which may be the same or different; m represents the number of the substituent groups Xs on each benzene ring, the numbers ms of the substituent groups on each benzene ring are independent of each other, which may be the same or different.

Wherein, the solvent comprises one or several of the following solvents: N-methyl pyrrolidone solvent, N-ethyl pyrrolidone solvent and butyrolactone solvent.

Wherein, the weight of the solvent accounts for 80-99% of the total weight of the alignment film material.

Wherein, the molecular weight of the polymer is greater than 10,000, and the molecular weight of the oligomer is less than 10,000.

Wherein, the alignment film material further comprises a leveling agent and a defoamer.

The embodiment according to the present invention has the beneficial effects as follow.

The alignment film material provided in the embodiment of the present invention comprises at least one polymer. The side chain of the polymer comprises the group structure of benzophenone. Because the benzophenone structure is very sensitive to the UV light, it can absorb the UV light energy in a wider spectral range and decompose to form free radicals, which results in the polymerization reaction of the monomer and increases the reaction rate and conversion efficiency of the monomer. Simultaneously, the structure group connects with the methyl acrylate group, which can polymerize by itself. Therefore, the free radicals or charged molecular fragments generated by which are able to participate in the polymerization reaction and attach to the polymer, which will not result in the high ion concentration.

### BRIEF DESCRIPTION OF THE DRAWINGS

To illustrate clearly the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort.

FIG. 1 is a schematic diagram of a liquid crystal display panel with polymer stabilized vertical alignment according to the present invention.

### DETAILED DESCRIPTION OF THE PREFERRED EMBODIMENTS

The detailed descriptions accompanying drawings and the embodiment of the present invention are as follows.

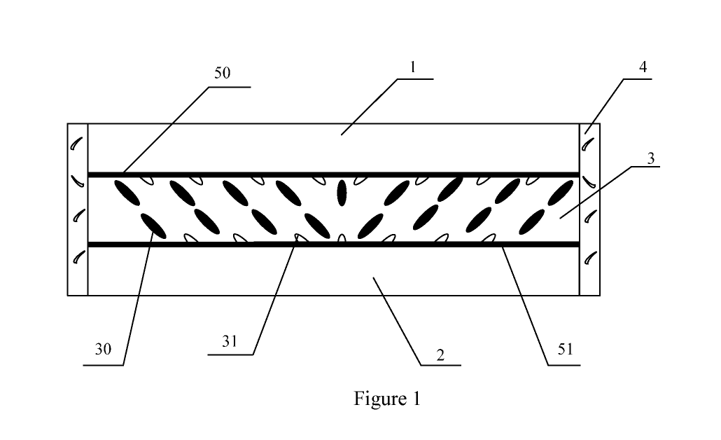

Referring to FIG. 1, it illustrates a schematic diagram of a liquid crystal display panel with polymer stabilized vertical alignment according to the present invention. The liquid crystal display panel is used for PSVA LCD, which comprises:

a first transparent substrate 1, which has a first alignment film 50;
a second transparent substrate 2, which has a second alignment film 51;
a liquid crystal composition 3, which is filled between the first transparent substrate 1 and the second transparent substrate 2, and the liquid crystal composition 3 contacts with the first alignment film 50 and the second alignment film 51; the liquid crystal composition comprising at least a liquid crystal molecule 30 and a polymerizable monomer; under the action of the first alignment film 50 and the second alignment film 51, the polymerizable monomer will form a Bump 31 near the first substrate 1 and second substrate 2; and a frame plastic material 4 sealing the liquid crystal within the two substrates;
wherein, the materials of the first alignment film and the second alignment film comprise:
a polymer, a oligomer, and a solvent, wherein, the polymer and/or the oligomer comprise group structures as following:

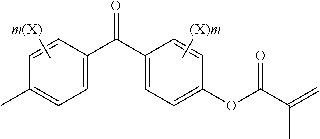

wherein, the group structure comprises a benzophenone structure, and is connected with methyl acrylate groups, X represents a substituent group, the substituent groups Xs at different positions are independent of each other, which may be the same or different; m represents the number of the substituent groups Xs on each benzene ring, the numbers ms of the substituent groups on each benzene ring are independent of each other, which may be the same or different.

Wherein, the solvent comprises one or several of the following solvents: N-methyl pyrrolidone solvent (NMP), N-ethyl pyrrolidone solvent (NEP) and butyrolactone solvent (Gamma-BL), and the weight of the solvent accounts for 80-99% of the total weight of the alignment film material. The molecular weight of the polymer is greater than 10,000, and the molecular weight of the oligomer is less than 10,000.

Moreover, the alignment film material further comprises a leveling agent and a defoamer.

The alignment film material provided in the embodiment of the present invention comprises at least one polymer. The side chain of the polymer comprises the group structure of benzophenone. Because the benzophenone structure is very sensitive to the UV light, it can absorb the UV light energy in a wider spectral range and decompose to form free radicals, which results in the polymerization reaction of the monomer and increases the reaction rate and conversion efficiency of the monomer. Simultaneously, the structure group connects with the methyl acrylate group, which can polymerize by itself. Therefore, the free radicals or charged molecular fragments generated by which are able to participate in the polymerization reaction and attach to the polymer, which will not result in the high ion concentration.

The embodiments according to the present invention regulates the reaction rate of the polymerizable monomer and the polymerizable monomer residues in the PSVA crystal mixture using the alignment film material, which controls the contents of the movable ion in the liquid crystal panel, in order to improve the reliability of the quality of the LCD panel.

The preferred embodiments according to the present invention are mentioned above, which cannot be used to define the scope of the right of the present invention. Those modifications and variations are considered encompassed in the scope of protection defined by the clams of the present invention.

What is claimed is:

1. An alignment film material, which is used for a liquid crystal display with polymer stabilized vertical alignment, characterized in that the alignment film material comprises: a polymer, an oligomer, and a solvent, wherein, the polymer and/or the oligomer comprise group structures as following: 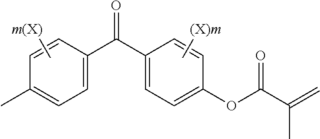
wherein, X represents a substituent group, the substituent groups Xs at different positions are independent of each other, which may be the same or different; m represents the number of the substituent groups Xs on each benzene ring, the numbers ms of the substituent groups on each benzene ring are independent of each other, which may be the same or different;
the solvent comprises one or several of the following solvents: N-methyl pyrrolidone solvent, N-ethyl pyrrolidone solvent and butyrolactone solvent; and the weight of the solvent accounts for 80-99% of the total weight of the alignment film material.

2. The alignment film material as claimed in claim 1, characterized in that the molecular weight of the polymer is greater than 10,000, and the molecular weight of the oligomer is less than 10,000.

3. The alignment film material as claimed in claim 2, characterized in that the alignment film material further comprises a leveling agent and a defoamer.

4. An alignment film material, which is used for a liquid crystal display with polymer stabilized vertical alignment, characterized in that the alignment film material comprises: a polymer, an oligomer, and a solvent, wherein, the polymer and/or the oligomer comprise group structures as following: 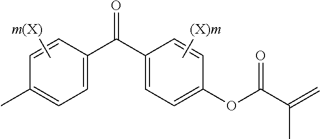
wherein, X represents a substituent group, the substituent groups Xs at different positions are independent of each other, which may be the same or different; m represents the number of the substituent groups Xs on each benzene ring, the numbers ms of the substituent groups on each benzene ring are independent of each other, which may be the same or different.

5. The alignment film material as claimed in claim 4, characterized in that the solvent comprises one or several of the following solvents:
N-methyl pyrrolidone solvent, N-ethyl pyrrolidone solvent and butyrolactone solvent.

6. The alignment film material as claimed in claim 5, characterized in that the weight of the solvent accounts for 80-99% of the total weight of the alignment film material.

7. The alignment film material as claimed in claim 6, characterized in that the molecular weight of the polymer is greater than 10,000, and the molecular weight of the oligomer is less than 10,000.

8. The alignment film material as claimed in claim 4, characterized in that the alignment film material further comprises a leveling agent and a defoamer.

9. The alignment film material as claimed in claim 5, characterized in that the alignment film material further comprises a leveling agent and a defoamer.

10. The alignment film material as claimed in claim 6, characterized in that the alignment film material further comprises a leveling agent and a defoamer.

11. The alignment film material as claimed in claim 7, characterized in that the alignment film material further comprises a leveling agent and a defoamer.

12. A liquid crystal panel, characterized in that the liquid crystal panel comprises:
a first transparent substrate, which comprises a first alignment film;
a second transparent substrate, which comprises a second alignment film; and
a liquid crystal composition, which is filled between the first transparent substrate and the second transparent substrate, and the liquid crystal composition contacting with the first alignment film and the second alignment film;
wherein, the alignment film material comprises: a polymer, a oligomer, and a solvent, the polymer and/or the oligomer comprise group structures as following: 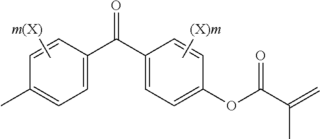
wherein, X represents a substituent group, the substituent groups Xs at different positions are independent of each other, which may be the same or different; m represents the number of the substituent groups Xs on each benzene ring, the numbers ms of the substituent groups on each benzene ring are independent of each other, which may be the same or different.

13. The alignment film material as claimed in claim 12, characterized in that the solvent comprises one or several of the following solvents:
N-methyl pyrrolidone solvent, N-ethyl pyrrolidone solvent and butyrolactone solvent.

14. The alignment film material as claimed in claim 13, characterized in that the weight of the solvent accounts for 80-99% of the total weight of the alignment film material.

15. The alignment film material as claimed in claim 14, characterized in that the molecular weight of the polymer is greater than 10,000, and the molecular weight of the oligomer is less than 10,000.

16. The alignment film material as claimed in claim 12, characterized in that the alignment film material further comprises a leveling agent and a defoamer.

17. The alignment film material as claimed in claim 13, characterized in that the alignment film material further comprises a leveling agent and a defoamer.

18. The alignment film material as claimed in claim 14, characterized in that the alignment film material further comprises a leveling agent and a defoamer.

19. The alignment film material as claimed in claim 15, characterized in that the alignment film material further comprises a leveling agent and a defoamer.
